(19) United States
(12) Patent Application Publication
(10) Pub. No.: US 2008/0005065 A1
(43) Pub. Date: Jan. 3, 2008

(54) Base business object key

(75) Inventors: Mark Skunberg, Moorhead, MN (US); William F. Pfingsten, Davenport, ND (US); Michael V. Lee, Fargo, ND (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/363,111

(22) Filed: Feb. 27, 2006

(51) Int. Cl. G06F 17/30

(52) U.S. Cl. 707/3

(57) ABSTRACT

The base business object key may be used to create business object keys. The base business object key may contain the data for the business object variations and the ability to perform the certain behaviors including comparison behaviors against that data.

### BACKGROUND

A business object is a logical representation of related business information. Examples may include customer, item and sales order. Physically, the data for any business object may be stored in several different formats and organized for efficiency. A business object instance is unique. In order to perform a behavior against a business object instance, the key to the business object must be known. Accordingly, the business object key must be exposed.

Some designers will expose a unique physical key. This approach places information into the business object that has no logical meaning. A sales order for customer “x984.5%” does not make sense. Some designers will expose the unique logical key, but will re-use key types (string key, date time key, string date time key . . . ) that describe these keys. This approach brings logical meaning into the business object, but only from a data perspective. It is not possible to programmatically understand what the customer is for a given sales order. One solution to the problem is to expose a unique logical key with a unique key type that corresponds to the business object (customer and customer key). The drawback to this approach is an explosion of types because every business object will need its own key type.

### SUMMARY

To solve the complexity of the explosion of key types, the base business object key may be used to create business object keys. The base business object key may contain the data for the business object key variations and the ability to perform certain behaviors against that data, including comparison functions. Business objects will have their own concrete key and they will expose logical property names that correspond to the business object. Child business object keys will include the parent business object key. Business objects will reference other business objects using the concrete keys.

### DRAWINGS

FIG. 1 is a block diagram of a computing system that may operate in accordance with the claims;

FIG. 2 is an illustration of a flowchart of a method of creating a business object key in accordance with the claims;

FIG. 3 is an illustration of a flowchart that illustrates the logical steps that need to be performed to create a concrete business object key; and

FIG. 4 may be a graphic illustration of one example of the method.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

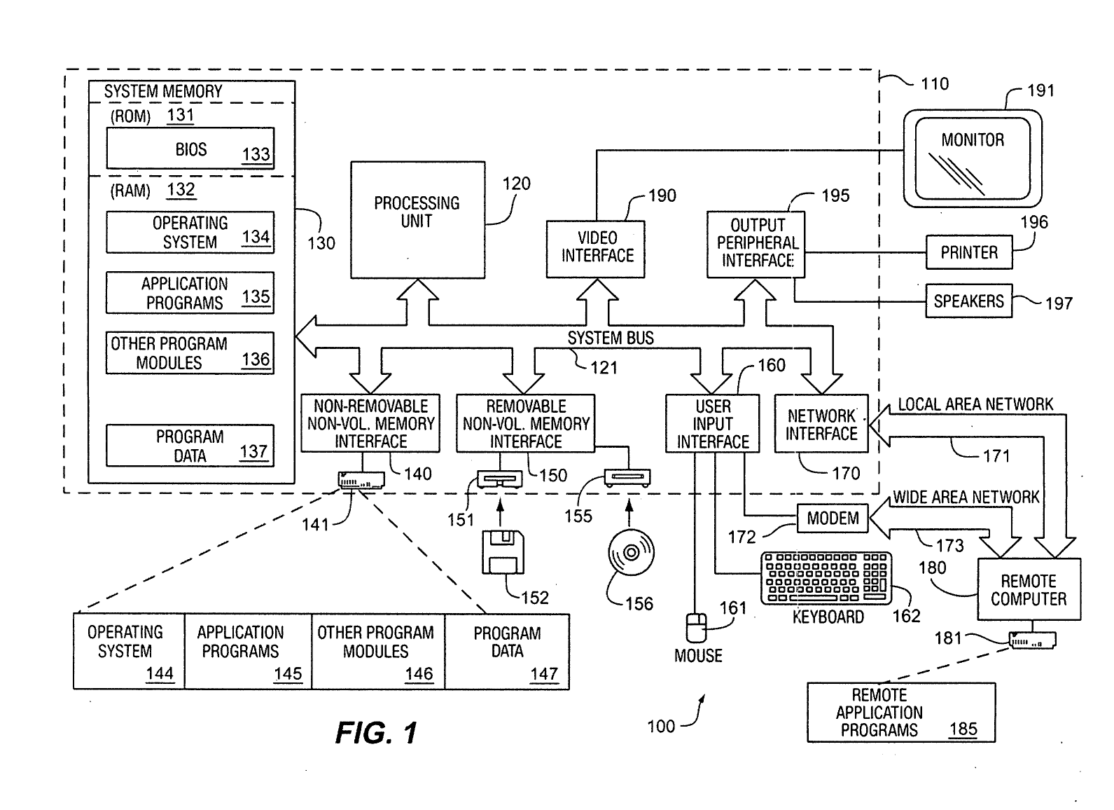

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

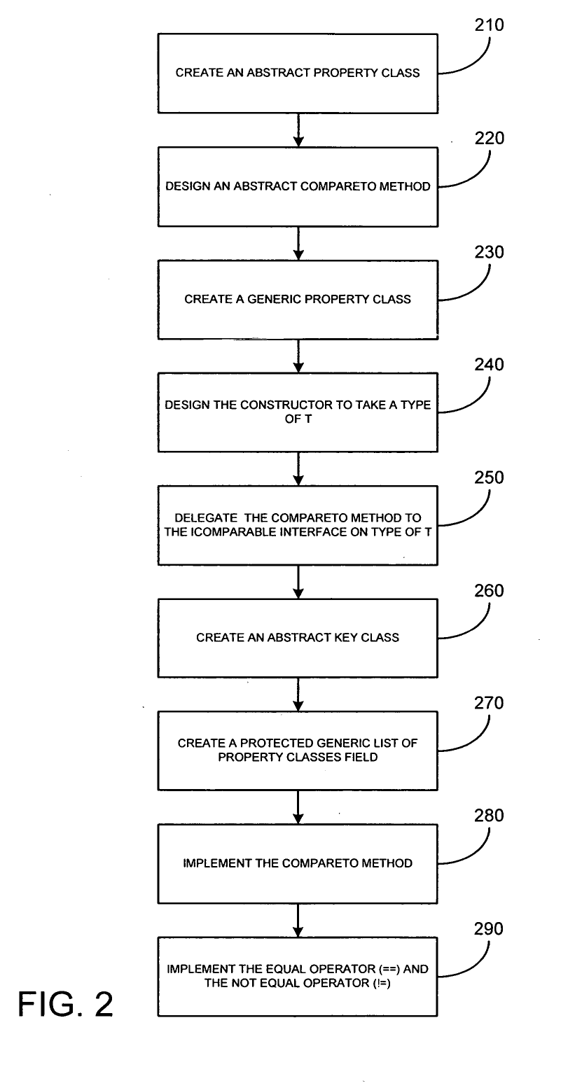

FIG. 2 may illustrate a method for creating a base business object key class that can perform comparison behaviors for all derived business object keys without restricting the property types to a specific set. A business object may be a logical representation of related business information. Examples of business objects may include a customer, an item, or a sales order. A base business object key class may perform comparison behaviors for all derived business object keys without restricting the property types to a specific set. In summary, a business object key may expose any type of property by using a generic list of abstract properties, then overriding the abstract property to be a single generic property, next implementing a ValueOfProperty property on the generic property to expose the underlying generic type and may delegate its comparison behaviors to each of its properties by calling the IComparable interface on type of T of the generic property class.

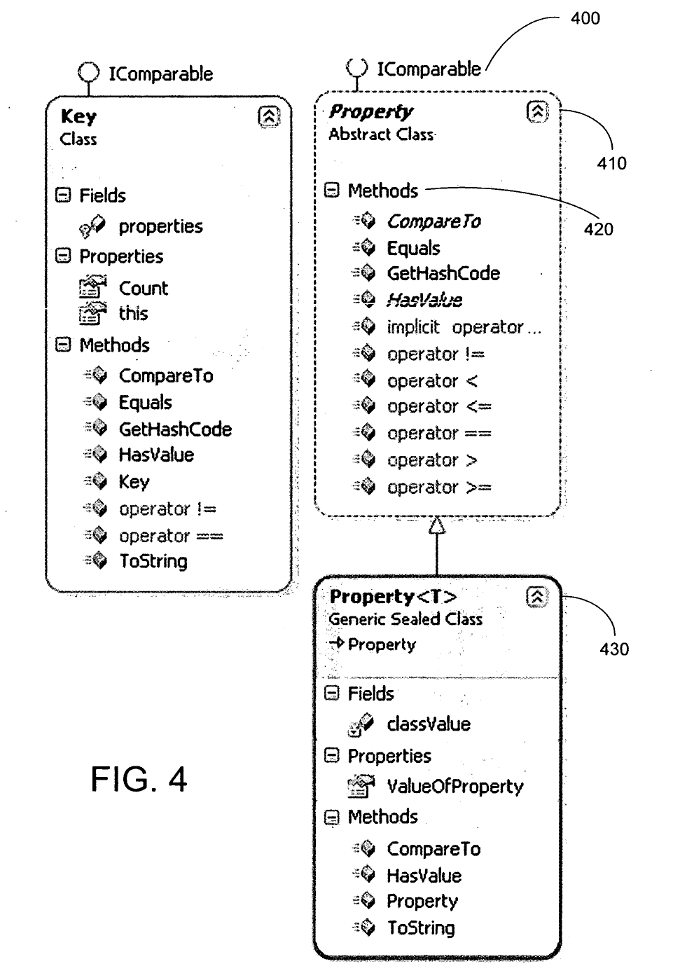

At block 210, the method may create an abstract property class (Property) that implements the IComparable interface. FIG. 4 may be a graphical illustration of the blocks in FIG. 2. The IComparable interface 400 may be implemented by delegating the comparison logic to property classes such that the classes may perform comparisons and issues that often arise when trying to design a logic function for a variety of types may be eliminated as the types themselves may perform the logic. Of course, the IComparable interface may have any name so long as the name is used consistently and does not use the name of another interface.

At block 220 (FIG. 2), the method may design an abstract CompareTo method 420 (FIG. 4) on the property class 410 to satisfy the IComparable interface 400 and delegate its implementation to a derived class. The CompareTo method may be a method that derived classes implement to allow comparisons of a variety of different types. Again, the name of the method is not especially significant so long as it is used consistently and is not a repeat of another method.

At block 230 (FIG. 2), the method may create a generic property class (Property<T>) 430 (FIG. 4) that derives from the property class (Property) 410. Because the class is generic, the class can contain any Type of T. Generics may use type parameters which may make it possible to design classes and methods that defer the specification of one or more types until the class or method is declared and instantiated by client code. Type of T is a name and may be varied so long as the varied name is used consistently.

At block 240, the method may design the constructor to take a Type of T and hold this Type as a private instance variable (classValue). As the variable is private, it is exposed a public property (ValueOfProperty). At block 250, the method may implement the CompareTo method by delegating it to the IComparable interface on Type of T.

At block 260, the method may create an abstract key class (Key) that implements the IComparable interface. The abstract class may be intended to be used as a base class for derived key classes. The class Key may have another name so long as the name is used consistently.

At block 270, the method may create a protected generic list of property classes (protected List<Property> properties) field to allow derived Key classes to hold the data that makes up their concrete keys. The concrete key may assign implicit operators to derived classes. Again, the name may be varied so long as it used consistently.

At block 280, the method may implement the CompareTo method by looping over each property class (Property) in the protected generic property list delegating it to the IComparable interface on the property class (Property). Once the result from a property comparison is not equal, that result may be returned.

At block 290, the method may implement the equal operator (=) and the not equal operator (!=) by calling the CompareTo method, verifying the result and returning the correct Boolean result to make the key class easier to use.

As long as a Type of t implements the IComparable interface, it can become a property of the base business object key without any changes. For example, the Key Properties can hold any concrete type allowing child keys to contain their parent's key.

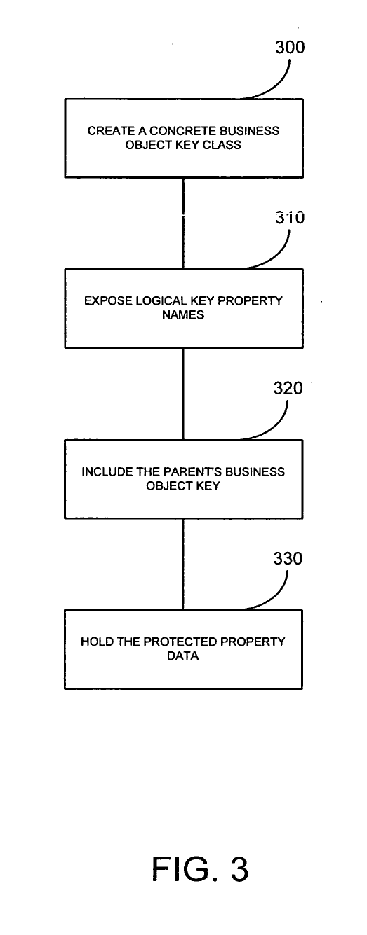

FIG. 3 may illustrate the logical steps that need to be performed to create a concrete business object key. At block 300, the method may create a concrete business object key class (CustomerKey) that derives from the abstract base business object key class (Key). Again, the specific names used are examples and may be varied so long as the names are used consistenly.

At block 310, the method may have the concrete business object key expose logical key property names (CustomerKey.PhoneNumber, for example) that correspond to the business object (Customer).

At block 320, when designing a concrete child business object key, (CustomerAddressKey), the method may include the parent's business object key in it (CustomerAddressKey.CustomerKey, for example) along with the properties that make it unique (CustomerAddressKey.AddressCode, for example).

At block 330, the method may have the base business object key hold the protected property data in its generic property list. At block 340, the method may create a business object (Customer) and have it contain the logical business object key class (Customer.Key where Key is the CustomerKey type).

Because the concrete business object key (CustomerKey) inherits from the base business object key (Key) and it (Key) implemented the comparison behavior, the derived business object key (CustomerKey) does not have to implement any comparison behaviors. This all works because the derived key keeps it data at the base level at which the comparison behavior is implemented.

The following may be code to implement a sample business object key.

[Serializable]
public class SomeBusinessObjectKey : Key
{

#region constructor
public SomeBusinessObjectKey( ) {

Property id = String.Empty;
properties.Add(id);

}
#endregion
#region key properties
public string SomePropertyName {

get { return properties[0]; }
set { properties[0] = value; }

}
#endregion

}

The “Property id=String. Empty;” line of code takes an empty string and assigns it to the abstract property. The statement will invoke the implicit string operator on the abstract property which will create a concrete Property<string> type and assign it to the id variable. This variable is then added to the protected properties list. After the property list is initialized, each business object key property (SomePropertyName) may reference its backing field by a known index. As a business object understands its unique logical key properties, it may define the key property name(s) that have meaning (SomePropertyName) and their corresponding type(s) (string). Because the properties list is protected, it is not visible by any outside consumer. The property getter and setter will both invoke implicit string operators on the abstract property to translate from Property<string> to string and string to Property<string>.

As a result of the methods, a base business object key may have the ability to have properties that are made up of any type that implements the IComparable interface. In addition, the base business object key may have the ability to contain another business object key. The comparison behaviors may be implemented by utilizing the underlying type comparison behaviors.

Variations may include, but are not limited to, every business object having its own logical key, every business object exposing logical key property names that correspond to their business object, every business object's associations referencing other business objects by their concrete logical keys and every child business object key including its parents business object key.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method for creating a base business object key class that can perform comparison behaviors for all derived business object keys without restricting the property types to a specific set comprising:
creating an abstract property class that implements a comparison interface;
designing an abstract comparison method on the property class to satisfy the comparison interface and delegate its implementation to a derived class;
creating a generic property class that derives from the property class;
designing a constructor to take a Type of T and hold this Type as a private instance variable and a public property;
implementing the abstract comparison method by delegating it to the comparison interface on Type of T;
creating an abstract key class that implements the comparison interface; creating a protected generic list of property classes field to allow derived classes from the abstract key class to hold the data that makes up their concrete keys; and
implementing the comparison method by looping over each property class in the protected generic property list delegating it to the comparison interface on the property class.

2. The method of claim 1, further comprising if a result from a property comparison in the looping is not equal, returning that result.

3. The method of claim 1, further comprising implementing the equal operator (=) and the not equal operator (!=) by calling the comparison method, verifying the result and returning the correct result.

4. The method according to claim 1, where the properties of Type T comprise properties of any type that implements a comparable interface.

5. A method according to claim 1, where the base business object key is capable of containing another business object key.

6. A method according to claim 1, further comprising referencing business objects by their concrete keys.

7. A method according to claim 1, further comprising including a parent business object key in its child's business object key.

8. A method according to claim 1, further comprising creating a concrete business object key class that derives from the abstract base business object key class.

9. The method according to claim 8, further comprising having the concrete business object key expose logical key property names that correspond to the business object.

10. The method according to claim 9, further comprising when designing a concrete child business object key, including the parent's business object key in it along with the properties that make it unique.

11. The method of claim 1, further comprising having the base business object key hold the protected property data in its generic property list.

12. The method of claim 1, further comprising creating a business object and having it contain the logical business object key class.

13. A computer readable medium with computer executable instructions, the computer executable instructions comprising instructions for:
creating an abstract property class that implements a comparison interface;
designing an abstract comparison method on the property class to satisfy the comparison interface and delegate its implementation to a derived class;
creating a generic property class that derives from the property class;
designing a constructor to take a Type of T and hold this Type as a private instance variable and a public property;
implementing the abstract comparison method by delegating it to the comparison interface on Type of T;
creating an abstract key class that implements the comparison interface;
creating a protected generic list of property classes field to allow derived classes from the abstract key class to hold the data that makes up their concrete keys;
implementing the comparison method by looping over each property class in the protected generic property list delegating it to the comparison interface on the property class;
if a result from a property comparison in the looping is not equal, returning that result; and
implementing the equal operator (=) and the not equal operator (!=) by calling the comparison method, verifying the result and returning the correct result.

14. The computer readable medium of claim 13, further comprising computer executable instructions for creating a concrete business object key class that derives from the abstract base business object key class.

15. The computer readable medium of claim 14, further comprising computer executable instructions for having the concrete business object key expose logical key property names that correspond to the business object.

16. The computer readable medium of claim 15, further comprising computer executable instructions for including the parent's business object key in it along with the properties that make it unique when designing a concrete child business object key.

17. The computer readable medium of claim 16, further comprising computer executable instructions for having the base business object key hold the protected property data in its generic property list and creating a business object and having it contain the logical business object key class.

18. A computer system comprising a processor, a memory and an input/output circuit, the memory storing computer executable instructions for the processor to execute, the computer executable instructions comprising instructions for:
creating an abstract property class that implements a comparison interface;
designing an abstract comparison method on the property class to satisfy the comparison interface and delegate its implementation to a derived class;
creating a generic property class that derives from the property class;
designing a constructor to take a Type of T and hold this Type as a private instance variable and a public property;
implementing the abstract comparison method by delegating it to the comparison interface on Type of T;
creating an abstract key class that implements the comparison interface;
creating a protected generic list of property classes field to allow derived classes from the abstract key class to hold the data that makes up their concrete keys;
implementing the comparison method by looping over each property class in the protected generic property list delegating it to the comparison interface on the property class;
if a result from a property comparison in the looping is not equal, returning that result;
implementing the equal operator (=) and the not equal operator (!=) by calling the comparison method, verifying the result and returning the correct result; and
creating a concrete business object key class that derives from the abstract base business object key class.

19. The computer system of claim 18, further comprising computer executable instructions for having the concrete business object key expose logical key property names that correspond to the business object.

20. The computer system of claim 18, further comprising computer executable instructions for having the base business object key hold the protected property data in its generic property list and creating a business object and have it contain the logical business object key class.
